(19) United States
(12) Patent Application Publication
(10) Pub. No.: US 2010/0010691 A1
(43) Pub. Date: Jan. 14, 2010

(54) Far End Remote Control Method and System

(76) Inventor: Andy LEN, Zhongli City (TW)

Correspondence Address: HDLS IPR Services, PO Box 220746, Chantilly, VA, 20153, US

(21) Appl. No.: 12/483,351

(22) Filed: Jun. 12, 2009

(30) Foreign Application Priority Data
Jul. 8, 2008 (TW) 097125644

(51) Int. Cl. G06F 17/00

(52) U.S. Cl. 701/2

(57) ABSTRACT

A far end remote control method and system relates to a remote control operating way, which includes a coordinate area, a central portion and an index. The coordinate area is partitioned into a number of quadrants. The central portion is located at the center of the coordinate area. The index is able to move within the coordinate area. The motion of a remote-controlled device such as a robot is decided by locating the index in a different quadrant. Besides, the strength of the motion of the remote-controlled device is further controlled by the distance between the index and the central portion.

### BACKGROUND OF THE INVENTION

1. Field of the Invention

The present invention relates to a far end remote control method and system, and more particularly to a remote control operating way. In particular, a coordinate area is partitioned into a number of quadrants and an index is located in the coordinate area for remote controlling a mechanical device.

2. Description of the Prior Art

Recently, military science and technology tends to develop an unmanned carrier instead of a soldier to enter a battleground, such as a pilotless fling machine, a remote-controlled mine sweeping vehicle, a detecting vessel in the deep sea.

Because the unmanned carrier provides the advantages of mobility and overcoming dangerous circumstances, the civilian industry also notices this trend. For example, an operating carrier having a video device and a remote-controlled robot enters a poisonous circumstance for working, or a small remote-controlled robot is operated to enter a space that is too small for a person to enter. Besides, a supervisor may operate a remote-controlled robot to go around and inspect a factory at a far end for saving management cost and monitoring effectively.

However, the remote-controlled robots on the market are not designed perfectly because the remote control way is operated by an exclusive controller to operate the remote-controlled robot. The size of the controller is not compact, which is inconvenient to carry. Besides, the exclusive controller is provided with many keys or joysticks for operating the remote-controlled robot to advance, to take a turn, to turn in situ and so on. The user has to be trained and practices enough so as to control the remote-controlled robot well.

### SUMMARY OF THE INVENTION

The primary objective of the present invention is to provide a far end remote control method and system which comprises an operating device and an executing device. The operating device comprises a terminal processor, a control peripheral unit, a first wireless communication unit, an index, and a coordinate area. The executing device comprises a second wireless communication unit, a kernel processing unit, a motion control processing unit, a power unit and a video unit.

The present invention is characterized in that the coordinate area is partitioned into a number of quadrants and each quadrant indicates a different motion command. The motion command includes advancing straight, advancing and turning, turning at a fixed point, turning round in situ, backing and turning, backing straight. By locating the index in one of quadrants, a motion corresponding to the quadrant is commanded. Moreover, the coordinate area has a central portion. The strength of the motion is further controlled by the distance between the index and the central portion.

For example, the executing device is a remote-controlled robot and the power unit is a power wheel. When the index is located in the quadrant of turning in situ, the remote-controlled robot will execute the motion of turning in situ. The closer the index in relation to the central portion is, the slower the rotating speed of the power wheel is. The speed of turning in situ of the remote-controlled robot is also slower. On the contrary, the farther the index in relation to the central portion is, the quicker the rotating speed of the power wheel is. The speed of turning in situ of the remote-controlled robot is also quicker.

### BRIEF DESCRIPTION OF THE DRAWINGS

FIG. 1 is a block diagram of an operating device and an executing device of the present invention;

FIG. 2 is a schematic view showing a coordinate area and an index of the present invention;

FIG. 3 is a schematic view of the present invention showing the index directing at AR quadrant;

FIG. 4 is a perspective view of the executing device of the present invention advancing and turning right;

FIG. 5 is a schematic view of the present invention showing the index directing at BR quadrant;

FIG. 6 is a perspective view of the executing device of the present invention turning right forward at a fixed point;

FIG. 7 is a schematic view of the present invention showing the index directing at CR quadrant; and

FIG. 8 is a perspective view of the executing device of the present invention turning right and round in situ;

### DETAILED DESCRIPTION OF THE PREFERRED EMBODIMENTS

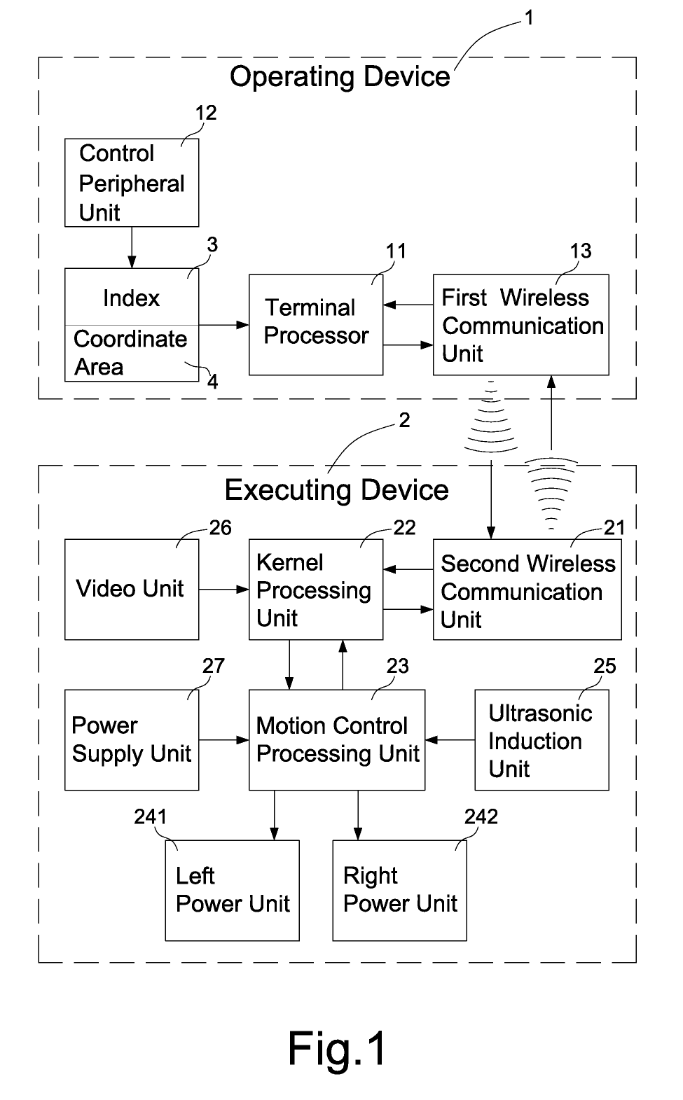

As shown in FIG. 1, a far end remote control method and system of the present invention comprises an operating device 1 and an executing device 2.

The operating device 1 comprises a terminal processor 11, a control peripheral unit 12, a first wireless communication unit 13, an index 3, and a coordinate area 4. The terminal processor 11 is a device capable of floating point operation to execute a program, such as a notebook or a cell phone having computer functions. The control peripheral unit 12 is a device connected to the terminal processor 11, such as a mouse, a contact plate, or a joystick. The first wireless communication unit 13 is a device to receive and send electric wave signals, such as a wireless network card for sending and receiving motion commands or other information. The index 3 is a directional member produced by executing the program with the terminal processor 11, which may be an arrow or a cross controlled by the control peripheral unit 12. The coordinate area 4 is an area produced by executing the program with the terminal processor 11. The index 3 is able to move within the coordinate area 4 for producing a motion command.

The executing device 2 comprises a second wireless communication unit 21, a kernel processing unit 22, a motion control processing unit 23, a left power unit 241, a right power unit 242, an ultrasonic induction unit 25, a video unit 26, and a power supply unit 27. The second wireless communication unit 21 is a device to receive and send electric wave signals, such as a wireless transmitter for sending and receiving motion commands or other information. The kernel processing unit 22 is adapted for receiving signals and commands and then sending signals to each unit after operation. The motion control processing unit 23 is adapted for operating and sending motion commands. The left power unit 241 is a rotatory power wheel to move after receiving the motion commands transmitted from the motion control processing unit 23. The right power unit 242 is a rotatory power wheel to move after receiving the motion commands transmitted from the motion control processing unit 23. The ultrasonic induction unit 25 is capable of sending ultrasonic waves and receiving the returned waves for measuring a relative distance. The video unit 26 is capable of taking a picture for the environmental scenery and converting the picture into digital signals to be sent to the kernel processing unit 22. The power supply unit 27 is a battery for supplying power to each unit of the executing device 2.

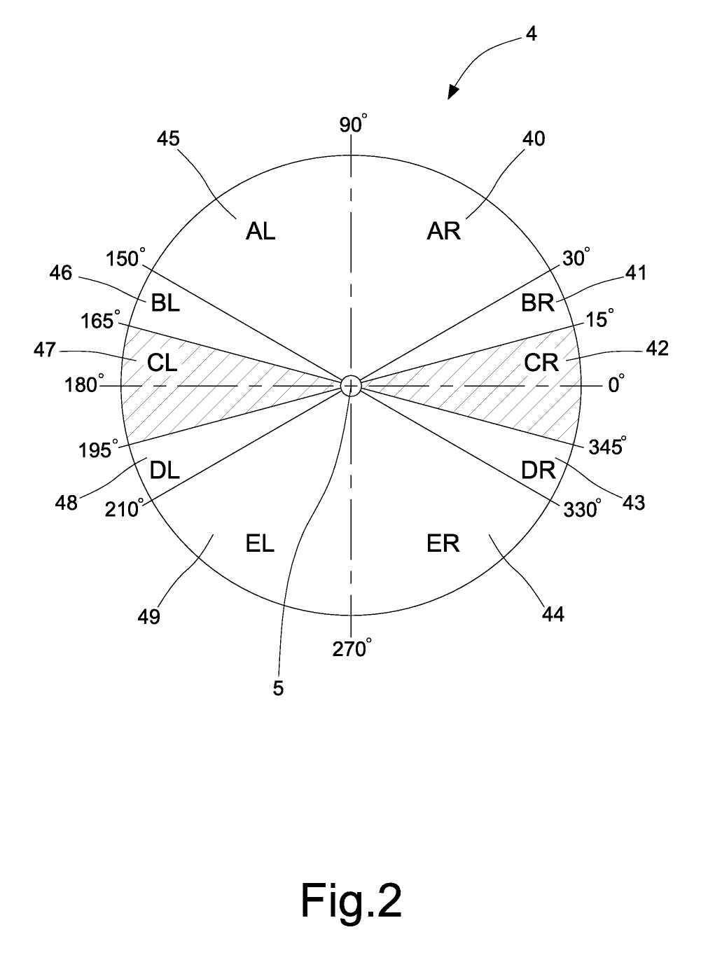

Referring to FIG. 2, the coordinate area 4 is partitioned into the following quadrants (the following quadrants and angles are only for purposes of illustration, not limited):

AR quadrant 40: corresponding to the motion command for advancing and turning right, its angle is in the range of 30 degrees to 90 degrees;

BR quadrant 41: corresponding to the motion command for turning right forward at a fixed point, its angle is in the range of 15 degrees to 30 degrees;

CR quadrant 42: corresponding to the motion command for turning right and round in situ, its angle is in the range of 15 degrees to 345 degrees;

DR quadrant 43: corresponding to the motion command for turning left backward at a fixed point, its angle is in the range of 330 degrees to 345 degrees;

ER quadrant 44: corresponding to the motion command for backing and turning right, its angle is in the range of 270 degrees to 330 degrees;

AL quadrant 45: corresponding to the motion command for advancing and turning left, its angle is in the range of 90 degrees to 150 degrees;

BL quadrant 46: corresponding to the motion command for turning left forward at a fixed point, its angle is in the range of 150 degrees to 165 degrees;

CL quadrant 47: corresponding to the motion command for turning left and round in situ, its angle is in the range of 165 degrees to 195 degrees;

DL quadrant 48: corresponding to the motion command for turning right backward at a fixed point, its angle is in the range of 195 degrees to 210 degrees; and

EL quadrant 49: corresponding to the motion command for backing and turning left, its angle is in the range of 210 degrees to 270 degrees.

The coordinate area 4 has a central portion 5 which is the intersection of the quadrants. The index 3 is able to move in each quadrant of the coordinate area 4.

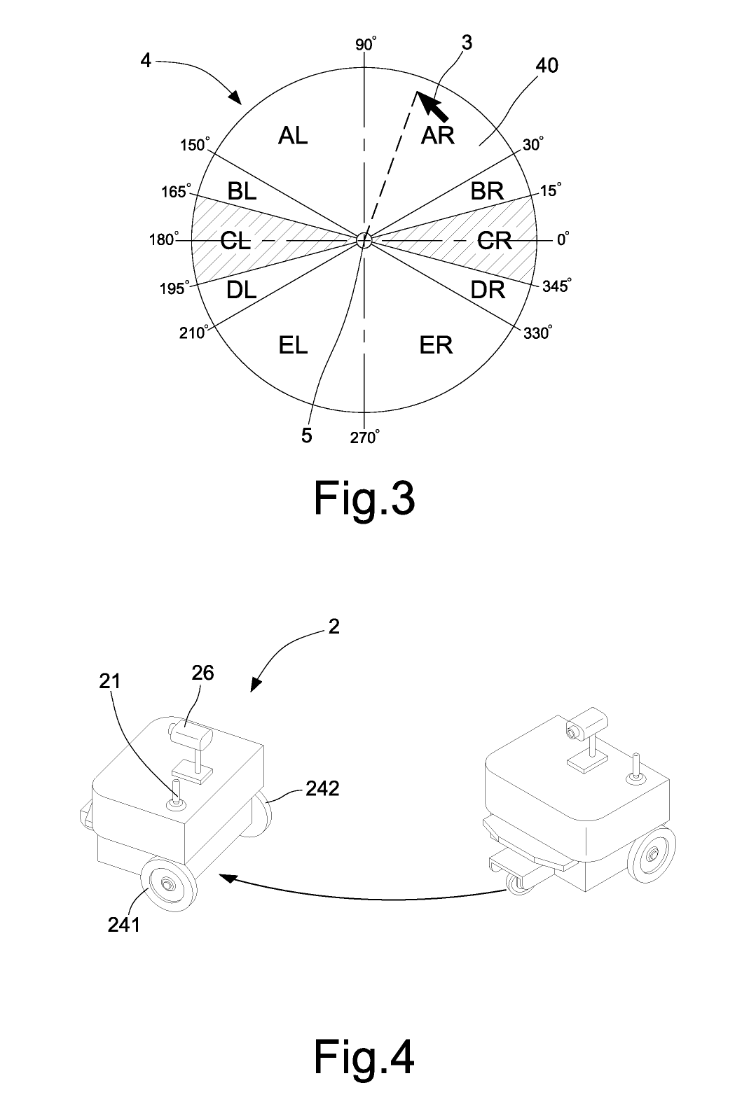

FIG. 3 shows the operation of the present invention. When the index 3 is moved to the AR quadrant 40, the motion control processing unit 23 will transmit a motion command to the left power unit 241 and the right power unit 242 to advance and turn right because the rotating speed of the left power unit 241 is greater than that of the right power unit 242, as shown in FIG. 4.

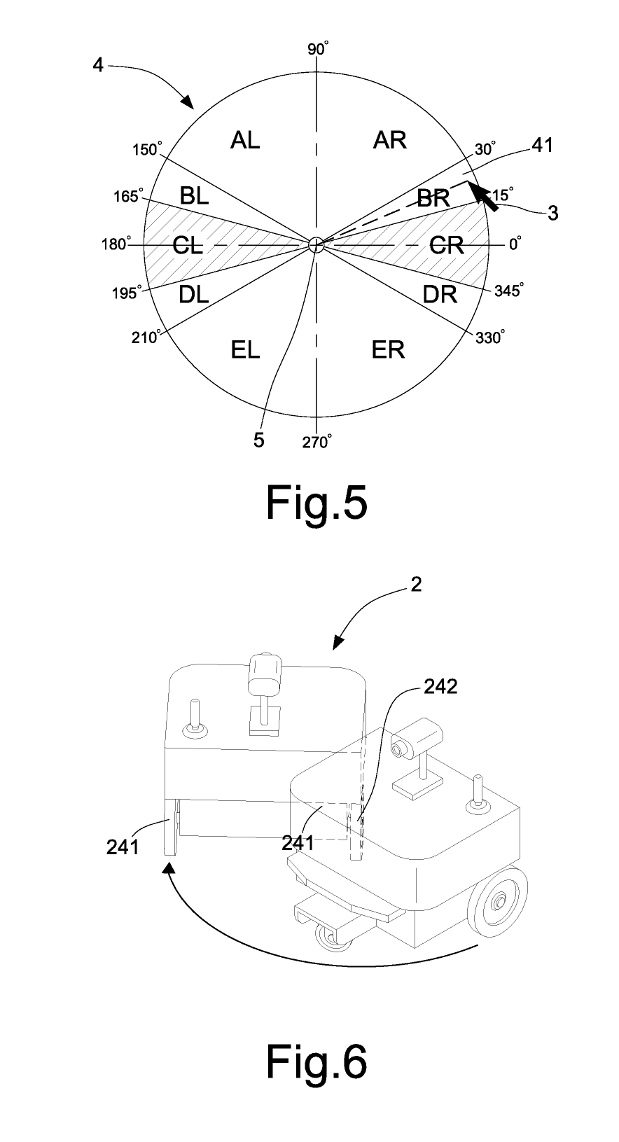

As shown in FIGS. 5 and 6, when the index 3 is moved to the BR quadrant 41, the left power unit 241 will advance and the right power unit 242 will stop moving for turning right at a fixed point.

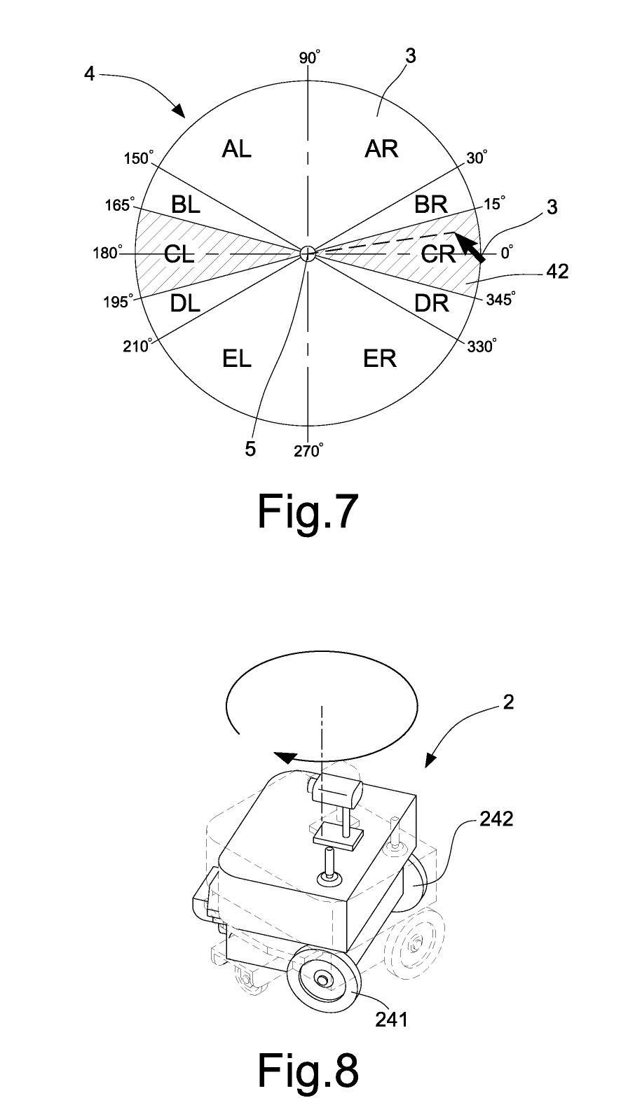

As shown in FIGS. 7 and 8, when the index 3 is moved to the CR quadrant 42, the left power unit 241 will advance and the right power unit 242 will back for turning right and round in situ.

The aforesaid instances are to explain the operations of advancing and turning right, turning right forward at a fixed point, and turning right and round in situ. The rest may be deduced by analogy. In addition, the rotating speeds of the left power unit 241 and the right power unit 241 are controlled by the distance between the index 3 and the central portion 5. For example, when the present invention is desired for turning right forward at a fixed point, the closer the index 3 in relation to the central portion 5 is, the slower the rotating speed of the left power unit 241 is. The speed of turning right forward at a fixed point is also slower. On the contrary, the farther the index 3 in relation to the central portion 5 is, the quicker the rotating speed of the left power unit 241 is. The speed of turning right forward at a fixed point is also quicker.

By the aforesaid method, it is easy to remote control the executing device for executing motions by using a notebook connected with a mouse or a cell phone having a contact plate as the operating device cooperated with a program and a wireless communication apparatus. Besides, the instinctive operation way is simply to understand. Thus, the present invention provides the effects of convenient installation and easy operation.

When the operating device of the present invention is a computer mouse, it may set to press a key of the mouse when in operation. The executing device will execute a motion when receiving a signal by pressing the key of the mouse. Once the key of the mouse is not pressed for sending a signal or the signal is interrupted, which means that the connection is abnormal. For ensuring the security of the executing device, the executing device will stop moving so as to prevent the executing device from collision because of unexpected movement or interrupted connection. If the operating device is not a computer mouse, it may be provided with a secure on-line key. The secure on-line key functions as the aforesaid mouse key to detect the connection status.

Furthermore, the distance between the index 3 and the central portion 5 is used to control the rotating speeds of the left power unit 241 and the right power unit 242, which may be varied by using the distance R valve between the index 3 and the central portion 5 as a parameter for calculating the rotating speeds of the left power unit 241 and the right power unit 242, wherein the algorithm for each quadrant of the coordinate area is different as follows:

when the index 3 is located in the AR quadrant 40, the rotating speed of the left power unit 241 will be R while the rotating speed of the right power unit 242 will be |R sin θ|;

when the index 3 is located in the BR quadrant 41, the rotating speed of the left power unit 241 will be R while the rotating speed of the right power unit 242 will be zero;

when the index 3 is located in the CR quadrant 42, the rotating speed of the left power unit 241 will be R while the rotating speed of the right power unit 242 will be minus R;

when the index 3 is located in the DR quadrant 43, the rotating speed of the left power unit 241 will be zero while the rotating speed of the right power unit 242 will be minus R;

when the index 3 is located in the ER quadrant 44, the rotating speed of the left power unit 241 will be minus R while the rotating speed of the right power unit 242 will be minus |R sin θ|;

when the index 3 is located in the AL quadrant 45, the rotating speed of the left power unit 241 will be |R sin θ| while the rotating speed of the right power unit 242 will be R;

when the index 3 is located in the BL quadrant 46, the rotating speed of the left power unit 241 will be zero while the rotating speed of the right power unit 242 will be R;

when the index 3 is located in the CL quadrant 47, the rotating speed of the left power unit 241 will be minus R while the rotating speed of the right power unit 242 will be R;

when the index 3 is located in the DL quadrant 48, the rotating speed of the left power unit 241 will be minus R while the rotating speed of the right power unit 242 will be zero; and

when the index 3 is located in the EL quadrant 49, the rotating speed of the left power unit 241 will be minus |R sin θ| while the rotating speed of the right power unit 242 will be minus

The parameters R and |R sin θ| indicate that the power unit moves forward. The parameters minus R and minus |R sin θ| indicate that the power unit moves backward. The parameter zero indicates that the power unit stops moving. The parameter θ is the angle of the coordinate point of the index 3.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A far end remote control method, comprising an operating device and an executing device, the operating device being operated to remote control the executing device for operation; the method further comprising a coordinate area and an index, wherein the coordinate area is partitioned into at least two quadrants with a central portion at the intersection of the quadrants; the index being moved to one of the quadrants to transmit a relative motion command.

2. The far end remote control method as claimed in claim 1, wherein the distance between the index and the central portion is adapted for resolving the strength of the motion.

3. The far end remote control method as claimed in claim 1, wherein the coordinate area is partitioned into AR quadrant, BR quadrant, CR quadrant, DR quadrant ER quadrant, AL quadrant, BL quadrant, CL quadrant, DL quadrant, and EL quadrant.

4. The far end remote control method as claimed in claim 3, wherein the AR quadrant corresponds to the motion command for advancing and turning right, and its angle is in the range of 30 degrees to 90 degrees; the BR quadrant corresponds to the motion command for turning right forward at a fixed point, and its angle is in the range of 15 degrees to 30 degrees; the CR quadrant corresponds to the motion command for turning right and round in situ, and its angle is in the range of 15 degrees to 345 degrees; the DR quadrant corresponds to the motion command for turning left backward at a fixed point, and its angle is in the range of 330 degrees to 345 degrees; the ER quadrant corresponds to the motion command for backing and turning right, and its angle is in the range of 270 degrees to 330 degrees; the AL quadrant corresponds to the motion command for advancing and turning left, and its angle is in the range of 90 degrees to 150 degrees; the BL quadrant corresponds to the motion command for turning left forward at a fixed point, and its angle is in the range of 150 degrees to 165 degrees; the CL quadrant corresponds to the motion command for turning left and round in situ, and its angle is in the range of 165 degrees to 195 degrees; the DL quadrant corresponds to the motion command for turning right backward at a fixed point, and its angle is in the range of 195 degrees to 210 degrees; the EL quadrant corresponds to the motion command for backing and turning left, and its angle is in the range of 210 degrees to 270 degrees.

5. The far end remote control method as claimed in claim 4, wherein the angle of each quadrant is adjustable in the range of 0 degree to 180 degrees but the total of the angles of all the quadrants is not more than 360 degrees.

6. The far end remote control method as claimed in claim 1, wherein the operating device comprises a terminal processor, a control peripheral unit, and a first wireless communication unit;
the terminal processor being a device capable of floating point operation to execute a program;
the control peripheral unit being connected to the terminal processor for operating the index;
the first wireless communication unit being a device to receive and send electric wave signals for sending and receiving the motion command and signals;
the index being a directional member produced by executing the program with the terminal processor and controlled by the control peripheral unit;
the coordinate area being an area produced by executing the program with the terminal processor;
wherein the executing device comprises a second wireless communication unit, a kernel processing unit, a motion control processing unit, a left power unit, a right power unit, an ultrasonic induction unit, a video unit, and a power supply unit;
the second wireless communication unit being a device to receive and send electric wave signals for sending and receiving the motion command or signals and being connected with the first wireless communication unit of the operating device;
the kernel processing unit being adapted for receiving the signals and command from the second wireless communication unit and sending signals to each unit of the operating device after operation;
the motion control processing unit being adapted for transmitting the motion command according to the signals from the kernel processing unit;
the left power unit being a rotatory power wheel to move after receiving the motion command transmitted from the motion control processing unit;
the right power unit being a rotatory power wheel to move after receiving the motion command transmitted from the motion control processing unit;
the ultrasonic induction unit being capable of sending ultrasonic waves and receiving returned waves for measuring a relative distance to be reported to the motion control processing unit;
the video unit being capable of taking a picture for an environmental scenery and converting the picture into digital signals to be sent to the kernel processing unit; and
the power supply unit being a battery for supplying power to the executing device.

7. The far end remote control method as claimed in claim 6, wherein the terminal processor is a notebook or a cell phone having computer functions, wherein the control peripheral unit a mouse, a contact plate, or a joystick, wherein the first wireless communication unit is a wireless network card, wherein the executing device is a remote-controlled robot.

8. The far end remote control method as claimed in claim 1, wherein the operating device is provided with a secure on-line key, the secure on-line key being adapted for transmitting a signal to the executing device to execute the motion command.

9. The far end remote control method as claimed in claim 8, wherein the secure on-line key is a mouse key.

10. The far end remote control method as claimed in claim 4, wherein the distance between the index and the central portion is used to decide rotating speeds of the left power unit and the right power unit, a R valve being defined as the distance between the index and the central portion, the R valve functioning as a parameter for calculating the rotating speeds of the left power unit and the right power unit, wherein an algorithm for each quadrant of the coordinate area is different as follows:
when the index is located in the AR quadrant, the rotating speed of the left power unit being R and the rotating speed of the right power unit being |R sin θ|;
when the index is located in the BR quadrant, the rotating speed of the left power unit being R and the rotating speed of the right power unit being zero;
when the index is located in the CR quadrant, the rotating speed of the left power unit being R and the rotating speed of the right power unit being minus R;
when the index is located in the DR quadrant, the rotating speed of the left power unit being zero and the rotating speed of the right power unit being minus R;
when the index is located in the ER quadrant, the rotating speed of the left power unit being minus R and the rotating speed of the right power unit being minus |R sin θ|;
when the index is located in the AL quadrant, the rotating speed of the left power unit being |R sin θ| and the rotating speed of the right power unit being R;
when the index is located in the BL quadrant, the rotating speed of the left power unit being zero and the rotating speed of the right power unit being R;
when the index is located in the CL quadrant, the rotating speed of the left power unit being minus R and the rotating speed of the right power unit being R;
when the index is located in the DL quadrant, the rotating speed of the left power unit being minus R and the rotating speed of the right power unit being zero; and
when the index is located in the EL quadrant, the rotating speed of the left power unit being minus |R sin θ| and the rotating speed of the right power unit being minus R;
the parameters R and |R sin θ| indicating that the power unit moves forward, the parameters minus R and minus |R sin θ| indicating that the power unit moves backward, the parameter zero indicating that the power unit stops moving, the parameter θ being the angle of the coordinate point of the index.

11. A far end remote control system, comprising an operating device and an executing device, wherein the operating device comprises a terminal processor, a control peripheral unit, a first wireless communication unit, an index, and a coordinate area;
the terminal processor being a device capable of floating point operation to execute a program;
the control peripheral unit being connected to the terminal processor for operating the index;
the first wireless communication unit being a device to receive and send electric wave signals for sending and receiving the motion command and signals;
the index being a directional member produced by executing the program with the terminal processor and controlled by the control peripheral unit;
the coordinate area being an area produced by executing the program with the terminal processor;
wherein the executing device comprises a second wireless communication unit, a kernel processing unit, a motion control processing unit, a left power unit, a right power unit, an ultrasonic induction unit, a video unit, and a power supply unit;
the second wireless communication unit being a device to receive and send electric wave signals for sending and receiving the motion command or signals and being connected with the first wireless communication unit of the operating device;
the kernel processing unit being adapted for receiving the signals and command from the second wireless communication unit and sending signals to each unit of the operating device after operation;
the motion control processing unit being adapted for transmitting the motion command according to the signals from the kernel processing unit;
the left power unit being a rotatory power wheel to move after receiving the motion command transmitted from the motion control processing unit;
the right power unit being a rotatory power wheel to move after receiving the motion command transmitted from the motion control processing unit;
the ultrasonic induction unit being capable of sending ultrasonic waves and receiving returned waves for measuring a relative distance to be reported to the motion control processing unit;
the video unit being capable of taking a picture for an environmental scenery and converting the picture into digital signals to be sent to the kernel processing unit; and
the power supply unit being a battery for supplying power to the executing device.

12. The far end remote control system as claimed in claim 11, wherein the terminal processor is a notebook or a cell phone having computer functions, wherein the control peripheral unit a mouse, a contact plate, or a joystick, wherein the first wireless communication unit is a wireless network card, wherein the executing device is a remote-controlled robot.

13. The far end remote control system as claimed in claim 11, wherein the operating device is provided with a secure on-line key, the secure on-line key being adapted for transmitting a signal to the executing device to execute the motion command.

14. The far end remote control system as claimed in claim 11, wherein the secure on-line key is a mouse key.

15. The far end remote control system as claimed in claim 11, wherein the operating device is operated to remote control the executing device for operation, wherein the coordinate area is partitioned into at least two quadrants with a central portion at the intersection of the quadrants; the index being moved to one of the quadrants to transmit a relative motion command.

16. The far end remote control system as claimed in claim 15, wherein the distance between the index and the central portion is adapted for resolving the strength of the motion.
